(19) United States
(12) Patent Application Publication
(10) Pub. No.: US 2013/0119124 A1
(43) Pub. Date: May 16, 2013

(54) COMBINING AN IMAGE WITH A SYMBOLOGY SELECTED IMAGE

(71) Applicant: Leigh M. ROTHSCHILD, Sunny Isles Beach, FL (US)

(72) Inventor: Leigh M. ROTHSCHILD, Sunny Isles Beach, FL (US)

(21) Appl. No.: 13/733,653

(22) Filed: Jan. 3, 2013

Related U.S. Application Data
(63) Continuation-in-part of application No. 13/470,235, filed on May 11, 2012.
Application No. 13/470,235 is a continuation of application No. 13/338,211, filed on Dec. 27, 2011.
Application No. 13/338,211 is a continuation of application No. 13/291,078, filed on Nov. 7, 2011.
Application No. 13/291,078 is a continuation-in-part of application No. 13/165,757, filed on Jun. 21, 2011.
Application No. 13/165,757 is a continuation of application No. 12/317,727, filed on Dec. 29, 2008, now Pat. No. 7,991,792.
Application No. 12/317,727 is a continuation of application No. 11/202,688, filed on Aug. 12, 2005, now Pat. No. 7,475,092.
Application No. 11/202,688 is a continuation-in-part of application No. 11/020,459, filed on Dec. 22, 2004.
Application No. 11/020,459 is a continuation-in-part of application No. 10/998,691, filed on Nov. 29, 2004, now Pat. No. 7,450,163.

(51) Int. Cl. G06F 17/30

(52) U.S. Cl. CPC G06F 17/30256
USPC 235/375

(57) ABSTRACT

A method and system for combining a first image associated with an encoded symbol with a second image selected by a user to produce a composite image are disclosed. According to one aspect, the invention provides a method that includes reading an encoded symbol using a mobile or portable device. A first image associated with the encoded symbol is retrieved based on information extracted from the encoded symbol. A second image associated with, or selected by, the user is retrieved. The first image and the second image are combined to form a composite image.

### CROSS REFERENCE TO RELATED APPLICATIONS

This application is a continuation-in-part of U.S. application Ser. No. 13/470,235, filed on May 11, 2012, which is a continuation of U.S. application Ser. No. 13/338,211, filed on Dec. 27, 2011, which is a continuation of U.S. application Ser. No. 13/291,078, filed on Nov. 07, 2011, which is a continuation-in-part of U.S. application Ser. No. 13/165,757, filed on Jun. 21, 2011, which is a continuation of U.S. application Ser. No. 12/317,727, filed on Dec. 29, 2008, now U.S. Pat. No. 7,991,792, which is a continuation of U.S. application Ser. No. 11/202,688, filed on Aug. 12, 2005, now U.S. Pat. No. 7,475,092, which is a continuation-in-part of U.S. application Ser. No. 11/020,459, filed on Dec. 22, 2004, which is a continuation-in-part of U.S. application Ser. No. 10/998,691, filed on Nov. 29, 2004, now U.S. Pat. No. 7,450,163.

### STATEMENT REGARDING FEDERALLY SPONSORED RESEARCH OR DEVELOPMENT

n/a

### FIELD OF THE INVENTION

The present invention relates to composite image creation, and in particular to combining an image with a symbology selected image.

### BACKGROUND OF THE INVENTION

A barcode is an optical machine-readable representation of data relating to the object to which it corresponds. Originally barcodes, such as the uniform product code (UPC), represented data by varying the width and spacing of parallel lines, and may be referred to as linear or one-dimensional (1D). An example of a one-dimensional bar code is shown in FIG. 1. Two dimensional codes, such as the quick response (QR) codes have also been developed. An example of a QR code is shown in FIG. 2.

Linear barcodes such as the UPC have become a ubiquitous element of modern civilization, as evidenced by their enthusiastic adoption by stores around the world; almost every item from a grocery store, department store, and mass merchandiser has a UPC barcode on it. This helps track items and also reduces instances of shoplifting involving price tag swapping, although shoplifters can now print their own barcodes. In addition, retail chain membership cards (issued mostly by grocery stores and specialty “big box” retail stores such as sporting equipment, office supply, or pet stores) use bar codes to uniquely identify consumers, allowing for customized marketing and greater understanding of individual consumer shopping patterns.

Barcodes can allow for the organization of large amounts of data. They are widely used in the healthcare and hospital settings, ranging from patient identification (to access patient data, including medical history, drug allergies, etc.) to medication management. They are also used to facilitate the separation and indexing of documents that have been imaged in batch scanning applications, track the organization of species in biology, and integrate with in-motion check weighing systems to identify the item being weighed in a conveyor line for data collection.

Barcodes can also be used to keep track of objects and people; they are used to keep track of rental cars, airline luggage, nuclear waste, registered mail, express mail and parcels. Barcoded tickets allow the holder to enter sports arenas, cinemas, theatres, fairgrounds, and transportation, and are used to record the arrival and departure of vehicles from rental facilities etc. This can allow proprietors to identify duplicate or fraudulent tickets more easily. Barcodes are widely used in shop floor control applications software where employees can scan work orders and track the time spent on a job. A disadvantage of the UPC bar codes is that the total number of items that may be represented is limited.

QR codes were first designed for the automotive industry. More recently, the system has become popular outside the automotive industry due to its fast readability and large storage capacity compared to standard UPC barcodes. The code consists of black modules (square dots) arranged in a square pattern on a white background. Unlike the 1-dimensional UPC bar code that was designed to be mechanically scanned by a narrow beam of light, the QR code is detected as a 2-dimensional digital image by a semiconductor image sensor and is then digitally analyzed by a programmed processor. The processor locates the three distinctive squares at the corners of the image, and normalizes image size, orientation, and angle of viewing, with the aid of a smaller square near the fourth corner. The small dots are then converted to binary numbers and validity checked with an error-correcting code.

Although initially used to track parts in vehicle manufacturing, QR Codes are now used over a much wider range of applications, including commercial tracking, entertainment and transport ticketing, and product coupons. QR codes may encode a Uniform Resource Locator (URL) to a website on the Internet.

A QR code, UPC code, or other code shall be referred to herein collectively as symbology or encoded symbols. An encoded symbol may be decoded using a decoder which may be a mobile application. Thus, mobile apps that decode UPC and QR codes may be installed in a mobile phone, allowing a mobile phone user to scan and interpret a bar code or QR code. For example, a mobile phone user shopping for a car may scan an encoded symbol affixed to the car. The mobile phone application may decode the encoded symbol to determine a link to a website that allows the mobile phone application to retrieve and display an image of the car. Desirably, the user may like to appear in the image of the car to see what the user looks like in or near the car. There is currently no simple way to do so using a mobile device or while at or near the car or without using sophisticated photo editing software. However, such sophisticated software cannot run on a mobile device, such as a smartphone, and typically requires a very powerful computer, such as a desktop computer. As another example, a mobile phone user visiting a scenic place such as the Grand Canyon may wish to be in the scene and have his/her picture taken, but there may be no one available or no one whom the user trusts to take the user's picture in the scene with the user's camera or mobile phone. Currently, there is no way for a user to combine an image taken of himself or others at a first place at a first time with an image taken at a second place at a second time while at the first place. For example there is no way for a user to easily see himself sitting in the car while at or near the car's location. Further, there is currently no way for a user to combine images selected based on bar codes associated with the images.

### SUMMARY OF THE INVENTION

The present invention advantageously provides a method and system for combining a first image associated with an encoded symbol with a second image selected by a user to produce a composite image. According to one aspect, the invention provides a method that includes reading an encoded symbol using a mobile or portable device. A first image associated with the encoded symbol is retrieved based on information extracted from the encoded symbol. A second image associated with, or selected by, the user is retrieved. The first image and the second image are combined to form a composite image.

According to another aspect, the invention provides an apparatus for combining a first image associated with a first encoded symbol with a second image selected by a user to produce a composite image. The apparatus includes a memory and a processor. The memory stores a first encoded symbol, a first image, a second image and a composite image. The processor decodes the first encoded symbol to determine a link to a first image, retrieves the first image, retrieves a second image and forms the composite image based on the first image and the second image.

According to yet another aspect, the invention provides a method of forming a composite image. The method includes scanning a first encoded symbol via a portable device. The first encoded symbol is decoded to determine a location of a first image. The first image is retrieved from the determined location. A second image is also retrieved from different location. The first image and the second image are combined to form a composite image. The combining includes orienting the first image with respect to the second image.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is a known 1-dimensional uniform product code;

FIG. 2 is a known 2-dimensional quick response code;

FIG. 3 is a block diagram of a scanner or camera constructed in accordance with principles of the present invention;

FIG. 4 is an image of a person;

FIG. 5 is an image of an automobile associated with an encoded symbol;

FIG. 6 is a composite image formed by combining the images of FIG. 3 and FIG. 4;

FIG. 7 is a flowchart of an exemplary process for acquisition of an image associated with an encoded symbol and combining the image with a user-selected image; and

FIG. 8 is a flowchart of an exemplary process for forming a new composite encoded symbol.

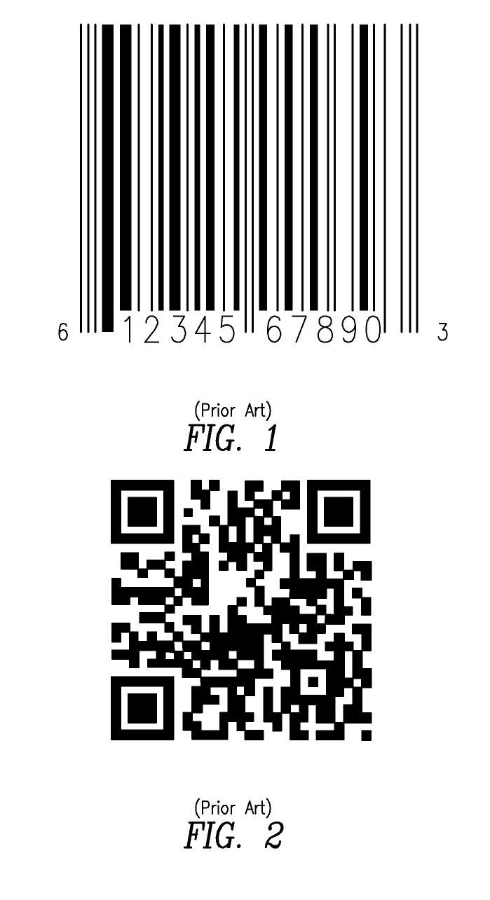

### DETAILED DESCRIPTION OF THE INVENTION

Before describing in detail exemplary embodiments that are in accordance with the present invention, it is noted that the embodiments reside primarily in combinations of apparatus components and processing steps related to creating a composite image from a symbology selected image and a user selected image. Accordingly, the system and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

As used herein, relational terms, such as “first” and “second,” “top” and “bottom,” and the like, may be used solely to distinguish one entity or element from another entity or element without necessarily requiring or implying any physical or logical relationship or order between such entities or elements.

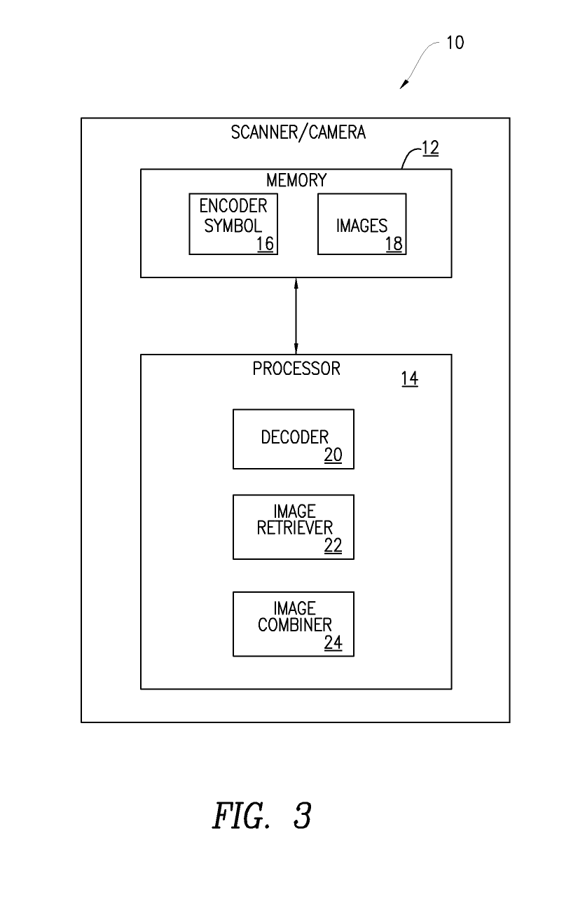

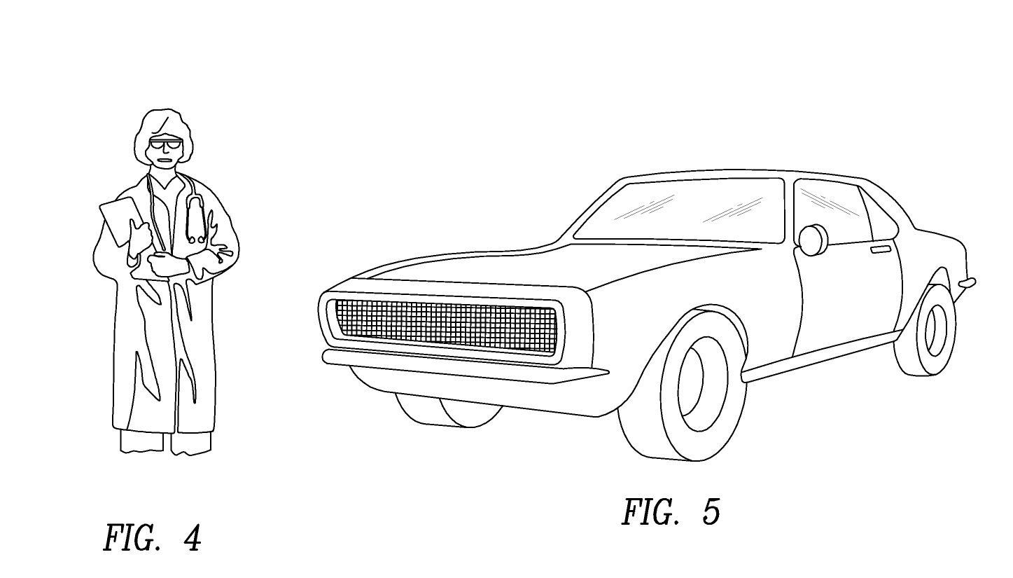

Referring now to the drawing figures, in which like reference designators denote like elements, there is shown in FIG. 3 a block diagram of a scanner or camera 10 constructed in accordance with principles of the present invention. The scanner/camera 10 includes a memory 12 and a processor 14. The memory 12 stores an encoded symbol 16 read by the scanner/camera 10 and stores images 18 retrieved by the scanner/camera 10.

The images 18 include an image associated with the encoded symbol 16, one or more images specified by a user of the scanner/camera 10 and a composite image formed by combining retrieved images with an image associated with the encoded symbol 16. The scanner/camera may be a standalone device or may be embedded in a portable or mobile device such as a mobile smart phone, mobile telephone, etc. For example, a mobile phone may have a camera embedded therein, and an application for decoding an encoded symbol, such as a UPC code or a QR code, that is captured by the camera.

The processor 14, operating under the directions of computer code, may implement a decoder 20, an image retriever 22 and an image combiner 24. The decoder 20 decodes an encoded symbol scanned or captured by the scanner/camera 10. The image retriever 22 retrieves an image associated with the encoded symbol and may also retrieve other images selected by a user of the scanner/camera 10. The image combiner 24 combines retrieved images to form a composite image.

Although the processor 14 shown in FIG. 3 includes a decoder 20, an image retriever 22 and an image combiner 24 in one single device, it will be understood by persons skilled in the art that these functions may be distributed among other computing devices accessible via a communication network. For example, a mobile phone may be equipped with an image capture device, e.g., camera, that captures the encoded symbol. The captured encoded symbol may be sent via a communication network to a computer that decodes the symbol to determine a link to a first image stored on a server accessible via the Internet. The computer may retrieve the first image via the Internet and a second image from a local or remote database and combine the first and second image to form the composite image. The composite image may be transmitted to the mobile device where it is displayed.

For example, the first image may be an image of a product, object or scene associated with the encoded symbol, such as an automobile, a printer, or a view of the Grand Canyon. The second image may be an image of the user. Thus, for example, the user may be visiting the Grand Canyon and wish to create a composite image of the user with the Grand Canyon in the background. The user may scan a barcode on a plaque mounted at the scene to retrieve an image of the scene. The user may then select an image of the user taken at a different time and possibly in a different location. The user's device which scanned the bar code may then combine the image of the scene with an image of the user in the foreground to create the composite image.

In another application, the user may find an image of a scene that is in a picture in a catalog that contains dozens or hundreds of images with a different UPC code or QR code placed near or on each image. The user may scan the encoded symbol which encodes a website where the picture associated with the encoded symbol can be downloaded. The user may then download the picture and combine it with an image of the user using a computing device such as the user's home computer. The combined image may be stored, displayed and printed.

The processor may also generate a second encoded symbol and associate the second encoded symbol with the composite image. Alternatively, the processor may generate a second encoded symbol and associate the second encoded symbol with the second user-associated image, and then combine the first encoded symbol and the second encoded symbol to create a composite encoded symbol representative of the composite image. Or, or the processor may instead associate the composite image with the original encoded symbol. Note also that the image itself may be encoded or a link to the image may be encoded.

The processor may also be configured to receive input to enable the user to alter features of the composite image and to alter relationships between the first and second images. For example, the input may enable the user to adjust an orientation and position of the first image with respect to the second image. The input may enable the user to choose which of the first and second images are in the foreground of the composite image. The input may enable the user to adjust a transparency of the first or second image. The input may enable the user to change a size or height of an image. The input may also enable the user to choose a color scheme for the individual images or the composite image. For example, a color of the first image may be selected to contrast with or complement a color of the second image.

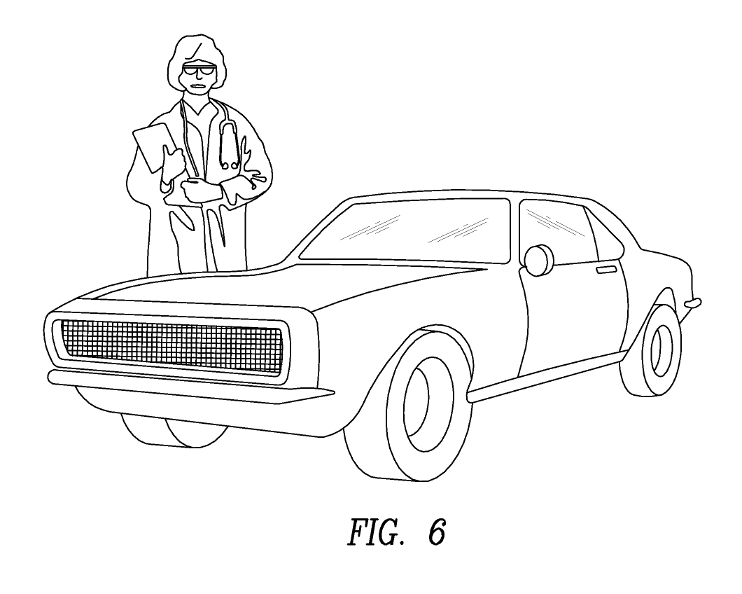

For example, FIG. 4 and FIG. 5 show two separate images. The image in FIG. 4 is of a person, who is, for example, a user of a mobile phone having a camera that can photograph a encoded symbol such as a UPC code or QR code. The image in FIG. 5 is a vehicle, which is associated with the encoded symbol. Thus, the user may capture an encoded symbol associated with the image of the vehicle via his or her mobile phone. The mobile phone may be equipped with a decoder application that decodes the encoded symbol to identify the vehicle and retrieve an image of the vehicle. FIG. 6 shows a composite image that is a combination of the images of FIGS. 4 and 5, where the image of the car is in the foreground and an image of the user is in the background. Optionally, the user may move the image of the car to the background so that the image of the user is in the foreground.

Numerous other ways of combining images and editing the composite image may also be implemented. For example, the user may change the relative sizes of the images in the composite image, change a transparency level of an image in the composite image, add text to the composite image, choose color schemes of the images in the composite image or cut and edit pieces of the composite image. Thus, in an exemplary embodiment, controls are displayed on a display of the scanner/camera 10 that enable the user to vary and edit features of the composite image and each of the images combined to form the composite image. As an example, the user may manipulate the image of a car associated with an encoded symbol with an image of the user so that the composite image shows the user in the car. The user may have access to a database with different photographs that may be combined with an image associated with an encoded symbol. The database may have images classified by preference, height, subject matter, position or orientation, etc.

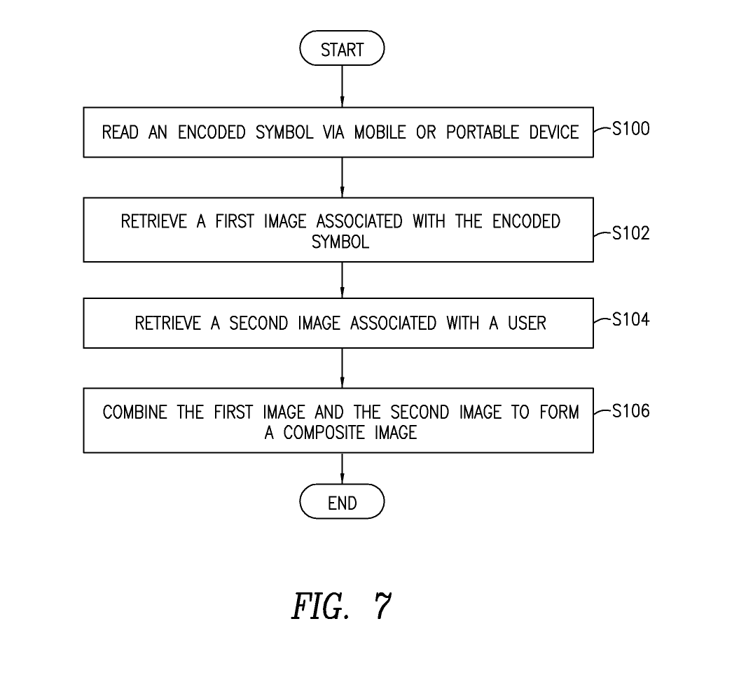

FIG. 7 is a flowchart of an exemplary process for forming a composite image from an image associated with an encoded symbol and an image associated with, or selected by, a user. An encoded symbol is read via a mobile or portable device such as a mobile phone (S100). A first image associated with the encoded information is retrieved based on information extracted from the encoded symbol (S102). A second image that is associated with, or selected by, a user of the mobile or portable device is retrieved (S104). The first image and the second image are combined by the portable device to form a composite image (S106).

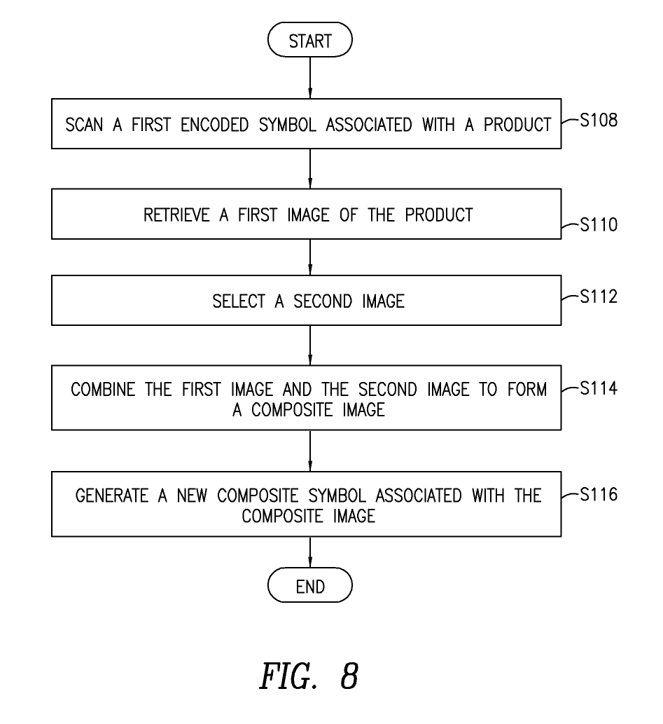

FIG. 8 is a flowchart of an exemplary process for forming a new composite symbol based on a first image associated with a first encoded symbol and a second image selected by a user. A first encoded symbol associated with a product, object or scene is scanned (S108). A first image is retrieved based on data from the encoded symbol (S110). A second image is selected by the user (S112). The first image and the second image are combined to form a composite image (S114). A new composite symbol associated with the composite image is generated (S116).

Thus, in some embodiments, a new encoded symbol is formed that encodes information about the composite image such as a link to a memory location where the composite image is stored. In other embodiments, a second encoded symbol is formed that is associated with an image selected by a user. Then, the first encoded symbol and the second encoded symbol may be combined to form a composite symbol representing the composite image. In yet another embodiment, the composite image is associated with the original encoded symbol.

The invention is not limited to embodiments that form a composite image of still photos only. The composite image may be a moving picture that is comprised of a first moving picture associated with an encoded symbol and a second still or moving picture associated with or selected by the user.

The present invention can be realized in hardware, or a combination of hardware and software. Any kind of computing system, or other apparatus adapted for carrying out the methods described herein, is suited to perform the functions described herein. A typical combination of hardware and software could be a specialized computer system, having one or more processing elements and a computer program stored on a storage medium that, when loaded and executed, controls the computer system such that it carries out the methods described herein. The present invention can also be embedded in a computer program product, which comprises all the features enabling the implementation of the methods described herein, and which, when loaded in a computing system is able to carry out these methods. Storage medium refers to any volatile or non-volatile storage device.

Computer program or application in the present context means any expression, in any language, code or notation, of a set of instructions intended to cause a system having an information processing capability to perform a particular function either directly or after either or both of the following a) conversion to another language, code or notation; b) reproduction in a different material form.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims.

What is claimed is:

1. A method of combining a first image associated with an encoded symbol with a second image associated with a user to produce a composite image, the method comprising:
reading the encoded symbol via a mobile device;
retrieving the first image associated with the encoded symbol based on information extracted from the encoded symbol;
retrieving the second image associated with the user; and
combining the first image and the second image to form the composite image.

2. The method of claim 1, wherein the encoded symbol is associated with a product and the composite image combines the second image and an image of the product.

3. The method of claim 1, further comprising adjusting a relationship between the first image and the second image via the mobile device.

4. The method of claim 3, wherein the relationship is at least one of an orientation and a position of the second image with respect to the first image.

5. The method of claim 3, wherein adjusting a relationship includes changing a size of the second image with respect to the first image.

6. The method of claim 3, wherein adjusting the relationship is based on a characteristic of a subject of the second image associated with the user.

7. The method of claim 1, further comprising adding text to the composite image.

8. The method of claim 3, wherein adjusting a relationship includes choosing a first color of an object in the first image based on a second color of an object in the second image.

9. The method of claim 1, further comprising cutting and editing the composite image.

10. The method of claim 1, wherein the composite image is associated with the encoded symbol within the mobile device.

11. An apparatus for combining a first image associated with a first encoded symbol with a second image selected by a user to produce a composite image, the apparatus comprising:
a memory, the memory adapted to store:
a first encoded symbol; and
a composite image; and
a processor in communication with the memory, the processor configured to:
decode the first encoded symbol to determine a link to the first image;
retrieve the first image based on the link;
retrieve the second image selected by the user; and
form the composite image by combining the first image and the second image.

12. The apparatus of claim 11, wherein the processor is further configured to:
generate a second encoded symbol; and
associate the second encoded symbol with the composite image.

13. The apparatus of claim 12, wherein the processor is further configured to generate the second encoded symbol using an algorithm that encodes the composite image.

14. The apparatus of claim 11, wherein the processor is further configured to:
generate a second encoded symbol associated with the second image; and
combine the first encoded symbol with the second encoded symbol to create a composite encoded symbol.

15. The apparatus of claim 11, wherein the processor is further configured to receive input to enable the user to alter features of the composite image.

16. The apparatus of claim 15, wherein the processor is configured to receive input to enable the user to adjust a transparency of one of the first and second image.

17. A method of forming a composite image, the method comprising:
scanning a first encoded symbol via a portable device;
decoding the first encoded symbol to determine a location of a first image of an object associated with the first encoded symbol;
retrieving the first image of the object;
selecting a second image; and
combining the first image and the second image to form the composite image, the combining including orienting the first image with respect to the second image.

18. The method of claim 17, further comprising generating a second encoded symbol associated with the composite image.

19. The method of claim 17, further comprising:
generating a second encoded symbol associated with the second image; and
combining the second encoded symbol with the first encoded symbol to form a composite encoded symbol associated with the composite image.

20. The method of claim 17, further comprising associating the composite image with the encoded symbol.
